(19) United States
(12) Patent Application Publication
(10) Pub. No.: US 2020/0325865 A1
(43) Pub. Date: Oct. 15, 2020

(54) Valve Assembly For An Injection Valve And Injection Valve

(71) Applicant: Continental Automotive GmbH

(72) Inventors: Antonio Agresta, Pisa (IT); Luigi Gargiulo, Pisa (IT); Ivano Izzo, Pisa (IT)

(73) Assignee: Continental Automotive GmbH, Hannover (DE)

(21) Appl. No.: 16/305,602

(22) PCT Filed: May 16, 2017
(86) PCT No.: PCT/EP2017/061763

§ 371 Date: Nov. 29, 2018

(30) Foreign Application Priority Data
Jun. 2, 2016 (EP) 16172621.1

(51) Int. Cl. F02M 51/06; F02M 61/10; B05B 1/30

(52) U.S. Cl. CPC F02M 51/0671; B05B 1/3053; F02M 61/10

(57) ABSTRACT

Valve assembly comprising: a valve body with an inlet and an outlet; a valve needle in the valve body preventing fluid flow through the outlet when closed and permitting the flow otherwise; a retaining element connected to the needle, extending radially and remote from the fluid outlet; and an electro-magnetic actuator to actuate the valve needle. The electro-magnetic actuator unit comprises an armature movable relative to the valve body. The armature defines a central axial opening through which the valve needle extends and slides on the valve needle. The retaining element limits the axial displacement of the armature. The armature comprises at least one axial slot arranged adjacent to and connected with the central axial opening, extending through the armature in the axial direction. The retaining element projects beyond the central axial opening and the axial slot projects beyond the retaining element in the radial outward direction.

### CROSS-REFERENCE TO RELATED APPLICATIONS

This application is a U.S. National Stage Application of International Application No. PCT/EP2017/061763 filed May 16, 2017, which designates the United States of America, and claims priority to EP Application No. 16172621.1 filed Jun. 2, 2016, the contents of which are hereby incorporated by reference in their entirety.

### TECHNICAL FIELD

The present disclosure relates to valves. Various embodiments may include a valve assembly for an injection valve and/or an injection valve, e.g. a fuel injection valve of a vehicle, e.g., solenoid injection valves.

### BACKGROUND

In vehicles, injection valves must be able to dose fluids even in the case of high fuel pressure. One design to ensure this is the “free-lift” design, an embodiment of which is disclosed in document EP 2 333 297 B1. According to this design, the armature of the electro-magnetic actuator unit travels about a “pre-stroke gap” before it engages the needle to open the injector. Thus, kinetic energy is accumulated before the actual opening. However, during the closing transient of such an injection valve, kinetic energy of the armature must be dissipated in order to avoid bounce and post injection events.

US 2011/198419 A1 discloses a fuel injection valve, which includes a needle valve having an engagement part and a movable core having an engagement part to be engaged with the engagement part of the needle valve. One of the engagement parts of the needle valve and the engagement part of the movable core is defined by two inner faces of a recess opposing to each other in an axis direction, and the other engagement part is defined by two outer faces of a projection opposing to the inner faces, respectively. The projection is movable between the inner faces in the axis direction in a state that the projection is located in the recess.

EP 2597296 B1 relates to a valve assembly for an injection valve, with a valve body including a central longitudinal axis, the valve body comprising a cavity with a fluid inlet portion and a fluid outlet portion, with a valve needle axially movable in the cavity, the valve needle preventing a fluid flow through the fluid outlet portion in a closing position and releasing the fluid flow through the fluid outlet portion in further positions, with an upper retainer being arranged in the cavity and being fixedly coupled to the valve needle, with an electro-magnetic actuator unit being designed to actuate the valve needle, the actuator unit comprising an armature arrangement which is arranged in the cavity and is axially moveable relative to the valve needle, the armature arrangement being designed to be coupled to the upper retainer when the valve needle is actuated to leave the closing position, the armature arrangement being designed and arranged to mechanically decouple from the upper retainer due to its inertia when the valve needle reaches the closing position.

The fuel injection valve disclosed by JP 2015-124612 A intends to suppress the overshoot of a valve body generated when opening a valve, without deteriorating responsivity, in a fuel injection valve having a valve portion separately composed of a valve body and an anchor. It has a valve portion in which a valve body formed in an axial direction of a body and opening/closing a nozzle port, and an anchor disposed on an outer periphery of the valve body, sucked to a fixed core by energization to an electromagnetic coil, and separated from the fixed core by the stopping of the energization to the electromagnetic coil can be relatively moved in an axial direction of the body. A fuel reservoir is formed between the anchor and the valve body, and the anchor is formed with a limiting channel for communicating the fuel reservoir and a fuel passage. The limiting channel intercepts communication with the fuel passage when the anchor is sucked to the fixed core.

### SUMMARY

The teachings of the present disclosure may be embodied in a valve assembly for an injection valve that overcomes the above mentioned difficulties and/or which provides a stable performance even under conditions of high fluid pressure. For example, some embodiments may include a valve assembly (3) for an injection valve (1), comprising a valve body (4) comprising a cavity (9) with a fluid inlet portion (5) and a fluid outlet portion (7), a valve needle (11) axially moveable in the cavity (9), the valve needle (11) preventing a fluid flow through the fluid outlet portion (7) in a closing position and releasing the fluid flow through the fluid outlet (7) portion in further positions, an upper retaining element (24) fixedly connected to the valve needle (11), extending in radial direction and being arranged in an axial region of the valve needle (11) remote from the fluid outlet portion (7); an electro-magnetic actuator unit (19) being operable to actuate the valve needle (11), the electro-magnetic actuator unit (19) comprising an armature (23) axially movable in the cavity (9) relative to the valve body (4), the armature (23) comprising a central axial opening (26) through which the valve needle (11) extends, the armature (23) being able to slide on the valve needle (11), the upper retaining element (24) limiting the axial displaceability of the armature (23), wherein the armature (23) comprises a number of axial slots (27) arranged adjacent to and connected with the central axial opening (26), the slots (27) extending through the armature (23) in axial direction, and the upper retaining element (24) projects beyond the central axial opening (26) in radially outward direction and the slots (27) project beyond the upper retaining element (24) in radial outward direction.

In some embodiments, the armature (23) is in sliding mechanical contact with the valve needle (11) or the upper retaining element (24) in the region of the central axial opening (26) and the slots (27) extend radially outward from the central axial opening (26).

In some embodiments, the axial slots (27) are semicircular in cross-section.

In some embodiments, the axial slots (27) are rectangular in cross-section.

In some embodiments, the axial slots (27) are straight and extend parallel to the needle (11).

In some embodiments, the axial slots (27) extend in axial direction in a curved manner.

In some embodiments, the axial slots (27) extend in axial direction along a helical curve.

In some embodiments, the slots (27) extend over at least one quarter of the circumference of the central axial opening (26).

In some embodiments, there is at least one outer axial slot (30) being spaced apart from the central axial opening (26) and from the slots (27) in radial direction and extending through the armature (23) in axial direction.

As another example, some embodiments include a injection valve (1) with a valve assembly (3) according to one the preceding description.

### BRIEF DESCRIPTION OF THE DRAWINGS

Further advantages, embodiments, and developments of the valve assembly for an injection valve, the fluid injection valve and the method for manufacturing a fluid injection valve will become apparent from the exemplary embodiments which are described below in association with schematic figures.

FIG. 1 shows a sectional view of an injection valve with a valve assembly incorporating teachings of the present disclosure;

FIG. 2 shows a cross-sectional detailed view of a first embodiment of an armature of the injection valve 1 according to FIG. 1; and

FIG. 3 shows a cross-sectional detailed view of a second embodiment of an armature of the injection valve 1 according to FIG. 1.

### DETAILED DESCRIPION

In some embodiments, a valve assembly for an injection valve comprises a valve body comprising a cavity with a fluid inlet portion and a fluid outlet portion and a valve needle axially moveable in the cavity. The valve needle prevents a fluid flow through the fluid outlet portion in a closing position and releases the fluid flow through the fluid outlet portion in further positions. In some embodiments, the valve assembly comprises an upper retaining element fixedly connected to the valve needle and extending in radial direction—i.e. in particular extending radially outward from the valve needle. The retaining element is preferably arranged in an axial region of the valve needle facing away from—i.e. in particular remote from—the fluid outlet portion.

In some embodiments, the valve assembly further comprises an armature. In some embodiments, the valve assembly comprises an electro-magnetic actuator unit being operable to actuate the valve needle and comprising the armature. The armature is axially movable in the cavity relative to the valve body. In some embodiments, it comprises a central axial opening through which the valve needle extends. The armature is able to slide on the valve needle, the upper retaining element limiting the axial displaceability of the armature relative to the valve needle, in particular in a first axial direction. In some embodiments, the axial displaceability of the armature relative to the valve needle in a second axial direction, opposite to the first axial direction is limited by a stopper which may be fixedly connected either to the valve needle or the valve body on the side of the armature remote from the upper retaining element. In some embodiments, the valve needle projects from the central axial opening, and in particular from the armature, in both axial directions.

In some embodiments, the armature further comprises a number of axial slots arranged adjacent to and connected with the central axial opening, the slots extending through the armature in axial direction. In some embodiments, each slot may extend over the entire length of the central axial opening, the length being the extension in axial direction. In some embodiments, the slots extend completely through the armature in axial direction. That the slots are “connected with the central opening” means the slots are connected to and open to the central axial opening on their entire length, the length being the extension in axial direction. To put it differently, that the slots are “connected with the central opening” means each slot has an interface fluidly connecting the slot to the central opening, the interface extending over the entire length of the slot.

In some embodiments, fluid may be squeezed through the slots during closing of the valve, thereby dissipating energy of the armature and dampening the armature. Fluid flow through the slots reduces hydraulic sticking between the armature and the upper retaining element, but at the same time keeps the impact face between the armature and the upper retaining element which helps prevent the reduction of parts surface durability. In some embodiments, the slots are arranged adjacent to the central opening such that they are fluidly connected with the central opening. In some embodiments, the slots extend radially outward from the central axial opening. Thus, the slots form a flow path along the inner diameter of the armature.

In some embodiments, there may only be one single slot or a larger number of slots. In order to keep a secure guidance of the needle, a number of about three to eight evenly spaced slots may be used.

In some embodiments, the armature is in sliding mechanical contact with the valve needle, in particular in the region of the central axial opening. In other words, a surface portion of the armature which defines the central axial opening is operable to slide along an outer circumferential surface of the valve needle for axially guiding the armature.

In some embodiments, the upper retaining element has a portion extending axially into the central axial opening of the armature so that it is arranged radially between the valve needle and the armature. In this case, the armature may be in sliding mechanical contact with the upper retaining element, in particular in the region of the central axial opening. In other words, the surface portion of the armature which defines the central axial opening is operable to slide along an outer circumferential surface of the above-mentioned portion of the upper retaining element for axially guiding the armature.

In this context “for axially guiding the armature” may imply that the needle is axially guided relative to the valve body, for example by means of a sliding contact of the upper retaining element with the valve body or another part of the valve assembly which is positionally fix relative to the valve body (such as a pole piece of the actuator unit). However also such embodiments shall include those where the armature actually guides the valve needle and the armature itself is axially guided relative to the valve body by sliding mechanical contact of an external surface of the armature with the valve body.

Particularly small tolerances of the armature/needle guidance may be achieved by these embodiments without increasing the bounce. This helps reduce dimensions of the injector. The quality of the needle guidance is not reduced by the slots.

In some embodiments, the upper retaining element projects beyond the central axial opening in radially outward direction. In one development, the upper retaining element is—or has a portion which is—arranged subsequently to the central axial opening in the first axial direction and projects beyond the central axial opening in radially outward direction. In this way, the armature is operable to engage with the upper retaining element in a form-fit connection for axially displacing the valve needle.

In some embodiments, the slots project beyond the upper retaining element in radial outward direction. In this way, particularly small hydraulic sticking between the upper retaining element and the armature is achievable.

In some embodiments, the axial slots are semicircular in cross-section. The term “semicircular” shall also denote a rounded cross-section that is not exactly semicircular. In other embodiments, the axial slots may also have a different cross-section, e.g. be rectangular in cross-section. The cross-sectional form of the slots has only a minor influence on the fluid flow as long as the slots do not get too narrow, thereby providing a considerable flow resistance. Therefore, the cross-sectional form may be chosen so as to simplify manufacture of the armature. The axial slots may be straight and extend parallel to the needle. In some embodiments, they may extend in axial direction in a curved manner. The curve may or may not be axially symmetric. For example, the axial slots may extend in axial direction along a helical curve. In some embodiments, the slots twist around the central opening in a helically curved fashion.

In some embodiments, the slots extend over at least one quarter of the circumference of the central axial opening. This means all the slots together extend over at least one quarter of the circumference of the central axial opening. In some embodiments, the slots extend over approximately 50% of the circumference. To put it differently, the armature has a central axial passage constituted by the central axial opening and the slots. The central axial passage is simply connected. The central axial opening and its interfaces with the slots may define an imaginary cylindrical surface. The interfaces of the slots with the central axial opening may make up at least one quarter of the imaginary cylindrical surface, for example about 50% of the imaginary cylindrical surface.

In some embodiments, the dimension, shape, and number of slots may be optimized based on the injector configuration. The hydraulic diameter of the flow path formed by the slots should be large enough to prevent hydraulic sticking between armature and upper retaining element.

In some embodiments, the valve assembly further comprises at least one outer axial slot—e.g. one or more through-holes—which is/are spaced apart from the central axial opening and from the slots in radial direction and extends through the armature in axial direction, for example parallel or oblique to the longitudinal axis. A particularly large hydraulic diameter is achievable with the slots and the outer axial slots together.

In some embodiments, the valve needle is a solid body. In some embodiments, the valve needle does not comprise a recess which extends axially through a portion of the valve needle for enabling fluid flow through the armature. This contributes to making the manufacture of the valve assembly cost-efficient and particularly precise. The valve needle may be particularly robust in this way.

In some embodiments, an injection valve includes the valve described above. The injection valve may in particular be a fuel injection valve of a vehicle.

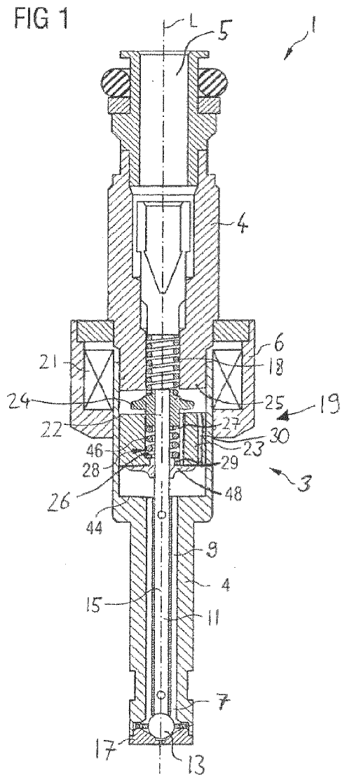

FIG. 1 shows an injection valve 1 that is suitable for dosing fuel to an internal combustion engine. The injection valve 1 comprises a valve assembly 3. The valve assembly 3 comprises a valve body 4 with a central longitudinal axis L. A housing 6 is partially arranged around the valve body 4. The valve body 4 comprises a cavity 9. The cavity 9 has a fluid outlet portion 7. The fluid outlet portion 7 communicates with a fluid inlet portion 5 which is provided in the valve body 4. The fluid inlet portion 5 and the fluid outlet portion 7 are positioned at opposite axial ends of the valve body 4. The cavity 9 takes in a valve needle 11. The valve needle 11 comprises a needle shaft 15 and a sealing ball 13 welded to the tip of the needle shaft 15.

In a closing position of the valve needle 11, it sealingly rests on a seat plate 17 having at least one injection nozzle. A preloaded calibration spring 18 exerts a force on the needle 11, biasing the valve needle 11 towards the closing position. The fluid outlet portion 7 is arranged near the seat plate 17. In the closing position of the valve needle 11, a fluid flow through the at least one injection nozzle is prevented. The injection nozzle may be, for example, an injection hole. However, it may also be of some other type suitable for dosing fluid.

The injection valve 1 is provided with an electro-magnetic actuator unit 19. The electro-magnetic actuator unit 19 comprises a coil 21, which may be arranged inside the housing 6, outside of the valve body 4. Furthermore, the electro-magnetic actuator unit 19 comprises an armature 23, being part of the valve assembly 3. The housing 6, parts of the valve body 4 and the armature 23 form an electromagnetic circuit. The actuator unit 19 further comprises a pole piece 25 fixed to or represented by the valve body 4.

The armature 23 is axially movable in the cavity 9. The armature 23 is axially movable relative to the valve needle 11, i.e. it may slide on the needle 11, and also to the valve body 4. At an axial end 22 of the valve needle 11 the valve assembly 3 comprises an upper retaining element 24. The upper retaining element 24 is formed as a collar around the axial end 22 of the valve needle 11. The upper retaining element 24 is fixedly coupled to the axial end 22 of the valve needle 11.

The needle 11 is guided by a central axial opening 26 in the armature 23. In some embodiments, a portion of the upper retaining element 24 extends axially into the central axial opening 26 so that it is arranged radially between the needle 11 and the armature 26. An outer surface of said portion is in sliding mechanical contact with an inner circumferential surface of the armature 23 which defines the central axial opening.

In some embodiments, a spring element 46 is arranged axially between the upper retaining element 24 and the armature 23. For example, it may be arranged in a recess 28 of the armature 23 between the upper retaining element 24 and a protrusion 29 of the armature 23. The spring element 46 enables a transmission of forces between the protrusion 29 of the armature 23 and the upper retaining element 24. The spring element 46 is preloaded so that in a closing position of the valve 1, the armature 23 is spaced apart from the upper retaining element 24 and in particular in contact with a lower retaining element 48.

The lower retaining element 48, also referred to as “hydraulic damping disc”, is axially positioned on the side of the armature 23 remote from the upper retaining element 24. In some embodiments, it is arranged in the cavity 9 axially between a step 44 of an inner surface of the valve body 4 and the armature 23. The lower retaining element 48 may be formed as a collar around the valve needle 11 and is fixedly attached to the valve needle 11.

The lower retaining element 48 can decrease the velocity of the armature 23 and ultimately stop the armature 23 when the valve needle 11 stops in the closed position and the armature 23 decouples from the upper retaining element 24 due to its inertia and moves further towards the fluid outlet portion 7.

In some embodiments, the armature 23 has a number of axial slots arranged adjacent to and connected with the central axial opening 26, the slots 27 extend through the armature 23 in axial direction. In the embodiment shown in FIG. 1, the axial slots 27 are straight and extend all the way parallel to the central axial opening 26. In FIG. 1, only one axial slot 27 is shown. However, the armature 23 may comprise a larger number of slots 27.

In some embodiments, a number of outer axial slots 30 are arranged in the armature 23. The outer axial slots 30 are not directly fluidly connected to the central opening. In other words, they are spaced apart from the central axial opening 26 and from the slots 27 in radial direction. They provide a flow path for fuel and can help prevent eddy currents. In some embodiments, the outer axial slots 30 are represented by through-holes extending through the armature 23 in axial direction.

In some embodiments, the upper retaining element 24 extends beyond the central axial opening 26 in radially outward direction so that it overlaps, in top view along the longitudinal axis, with a surface of the armature 23 facing towards the pole piece 25. In some embodiments, the valve needle 11 and the retaining element 24 together completely overlap the central axial opening 26. In the closing position of the valve 1, there is an axial gap between the upper retaining element 24 and the armature 23.

When the coil 21 is energized, the armature 23 experiences a magnetic force and slides upwards towards the pole piece 25, moving in axial direction away from the fluid outlet portion 7. After having travelled to close the gap, the armature 23 takes the valve needle 11 with it towards the pole piece 25 via a form-fit engagement of its surface facing towards the pole piece 25 with the upper retaining element 24. Consequently, the valve needle 11 moves in axial direction out of the closing position of the valve 1.

Outside of the closing position of the valve needle 11, a gap between the valve body 4 and the valve needle 11 at the axial end of the injection valve 1 facing away from of the actuator unit 19 forms a fluid path and fluid can pass through the injection nozzle. When the coil 21 is de-energized, the calibration spring 18 can force the valve needle 11 to move in axial direction into its closing position. At the end of the closing transient, the armature 23 detaches from the upper retaining element 24. This detachment is facilitated by fuel squeezed through the slots 27.

The kinetic energy of the armature 23 needs to be dissipated, to avoid needle bounce which may lead to an undesired reopening of the valve 1. A part of the kinetic energy may be dissipated by squeezing fuel through the slots 27 and 30.

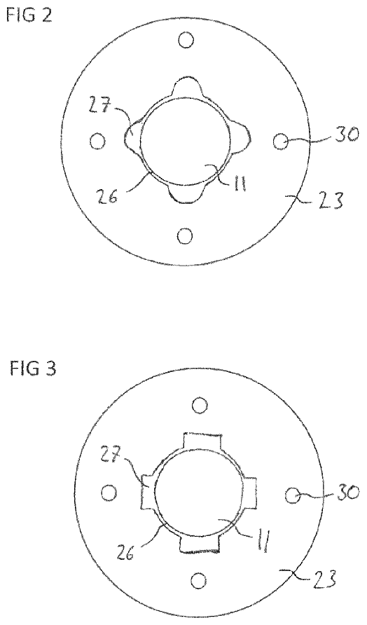

FIG. 2 shows a cross-sectional detailed view of a first embodiment of an armature 23 of the injection valve 1 according to FIG. 1. The armature 23 has four slots 27 arranged adjacent to the central axial opening 26. The slots 27 and the central axial opening 26 completely overlap each other in axial direction. In other words, the axial ends of the slots 27 and the central axial opening 26 are arranged at the same axial positions. The slots 27 are semicircular in cross-section, the opening of the semicircular shapes of the slots 27 representing the interfaces with the central axial opening 26. The cross-section of the slots 27 is in particular translation invariant with respect to translation along the longitudinal axis L. The slots 27 extend over approximately half the circumference of the central axial opening 26.

FIG. 3 shows a cross-sectional detailed view of a second embodiment of an armature 23 of the injection valve 1 according to FIG. 1. This embodiment only differs from the first in that the slots 27 are rectangular in cross-section. In some embodiments, the upper retaining element 24 completely overlaps the slots 27 in top view along the longitudinal axis L. In some embodiments, the slots 27 project beyond the upper retaining element 24 in radially outward direction.

What is claimed is:

1. A valve assembly for an injection valve, the assembly comprising:
a valve body defining a cavity with a fluid inlet and a fluid outlet;
a valve needle axially moveable within the cavity, the valve needle preventing a fluid flow through the fluid outlet in a closed position and permitting the fluid flow through the fluid outlet in further positions;
an upper retaining element fixedly connected to the valve needle, the upper retaining element extending in a radial direction and arranged in an axial region of the valve needle remote from the fluid outlet; and
an electro-magnetic actuator unit operable to actuate the valve needle, the electro-magnetic actuator unit comprising an armature axially movable in the cavity relative to the valve body;
the armature defining a central axial opening through which the valve needle extends, the armature sliding on the valve needle;
the upper retaining element limiting the axial displacement of the armature;
wherein the armature comprises at least one axial slot arranged adjacent to and connected with the central axial opening, the at least one slot extending through the armature in the axial direction; and
the upper retaining element projects beyond the central axial opening in the radially outward direction and the at least one axial slot projects beyond the upper retaining element in the radial outward direction.

2. A valve assembly according to claim 1, wherein the armature is in sliding mechanical contact with the valve needle in the region of the central axial opening and the at least one slot extends radially outward from the central axial opening.

3. A valve assembly according to claim 1, wherein the at least one axial slot has a semicircular cross-section.

4. A valve assembly according to claim 1, wherein the at least one axial slot has a rectangular cross-section.

5. A valve assembly according to claim 1, wherein the at least one axial slot is straight and extends parallel to the valve needle.

6. A valve assembly according to claim 1, wherein the at least one axial slot extends in the axial direction along a curve.

7. A valve assembly according to claim 1, wherein the at least one axial slot extends along a helical curve.

8. A valve assembly according to claim 1, wherein the at least one axial slot extends over at least one quarter of a circumference of the central axial opening.

9. A valve assembly according to claim 1, further comprising at least one outer axial slot spaced apart from the central axial opening and from the at least one axial slot in the radial direction and extending through the armature in the axial direction.

10. (canceled)

11. A valve assembly according to claim 1, wherein the armature is in sliding mechanical contact with the upper retaining element in the region of the central axial opening and the at least one axial slot extends radially outward from the central axial opening.
